(19) United States
(12) Patent Application Publication
(10) Pub. No.: US 2025/0131908 A1
(43) Pub. Date: Apr. 24, 2025

(54) METHODS, APPARATUSES AND COMPUTER PROGRAM PRODUCTS FOR PROVIDING ACTIVE VIBRATION CONTROL SYSTEMS

(71) Applicant: Meta Platforms Technologies, LLC, Menlo Park, CA (US)

(72) Inventors: Morteza Khaleghimeybodi, Bothell, WA (US); John Raymond Brodie, Bend, OR (US); Luke Allen, Woodinville, WA (US); Andrew Jackson Stockton X, Boston, MA (US); Nils Thomas Fritiof Lunner, Redmond, WA (US)

(21) Appl. No.: 18/923,437

(22) Filed: Oct. 22, 2024

Related U.S. Application Data
(60) Provisional application No. 63/592,834, filed on Oct. 24, 2023.

(51) Int. Cl. G10K 11/178

(52) U.S. Cl. CPC G10K 11/17881; G10K 11/17857; G10K 11/17885; G10K 11/17817; G10K 2210/108; G10K 2210/129; G10K 2210/501; G10K 2210/506

(57) ABSTRACT

A system and method for removal of unwanted vibration noise are provided. The system may detect, by a microphone(s) of the system, at least one audio signal including audio content output from at least one speaker and other audio data from one or more other sources, or caused by the one or more other sources. The other audio data may include determined undesirable vibration noise causing distortion of the at least one audio signal. The system may determine, by at least one sensor of the system, a subset of the other audio data based in part on determining at least one motion of a user of the system, or motion of one or more other users. The system may remove, or reduce, the undesirable vibration noise from the at least one audio signal to enable output of sound associated with a modification of the at least one audio signal.

### CROSS-REFERENCE TO RELATED APPLICATIONS

This application claims priority to U.S. Provisional Application No. 63/592,834, filed Oct. 24, 2023, entitled “Active Vibration Control Using Additional Sensors And Transducers,” which is incorporated by reference herein in its entirety.

### TECHNOLOGICAL FIELD

Exemplary aspects of this disclosure may relate generally to methods, apparatuses and computer program products for providing techniques that facilitate active vibration control approaches to reduce unwanted acoustic or mechanical vibrations associated with one or more sensor devices.

### BACKGROUND

In augmented reality (AR) devices or smart glasses/smart devices, there may be unwanted mechanical coupling or vibration paths from the rendering transducers to the microphones (mics) in a microphone array. In particular, this may be an important issue when the device (e.g., an AR device) is being used as a hearing amplification device to amplify the environmental sounds (e.g., a hearing enhancement or hearing correction glasses). This unwanted mechanical coupling/vibration, exhibited by existing systems, may limit the overall gain that may be provided in hearing enhancement scenarios (e.g., conversation focus, hearing enhancement and correction use cases).

As such, it may be beneficial to provide efficient and reliable mechanisms that provide enhanced techniques to minimize or entirely remove these unwanted mechanical or acoustic vibrations, which may help improve the maximum stable gain (MSG) of a device.

### BRIEF SUMMARY

Some examples of the present disclosure may utilize active vibration control (AVC) approaches to reduce unwanted mechanical or acoustic vibrations coupling to one or more microphones of a microphone array.

In this regard, some example aspects of the present disclosure may relate to an active vibration control system(s) for smart glasses and/or artificial reality systems. The active vibration control systems for the smart glasses may utilize a transducer (e.g., a moving coil or moving magnet loudspeaker or a piezoelectric transducer) to create sound for the users of the smart glasses. This may be the case in an instance in which electromagnetic transducers (e.g., either with moving coil or moving magnets) may be used to create the sound. The vibrations created based on a speaker's elements may travel to other areas on the smart glasses and may cause unwanted noise or unwanted vibrations at sensors such as, for example, microphones, cameras, inertial measurement units (IMUs), etc. In this regard, some example aspects of the present disclosure may utilize an active vibration control system(s) to attenuate the sensed vibrations at these sensors. Active vibration control may involve the active application of force in an equal but opposite fashion to the forces imposed by external vibration (e.g., forces originating from the vibrations of a speaker(s)).

Some example aspects of the present disclosure may provide an active vibration control system(s) for smart glasses and/or artificial reality systems that may utilize a feedback control mechanism(s) to attenuate sensed vibrations at sensors such as microphones, inertial measurement units (IMUs), cameras, etc. In some example aspects, the active vibration control system(s) may include a secondary source(s) (e.g., an audio-band shaker, a transducer (e.g., a wide-bandwidth piezoelectric transducer, a bone conduction shaker, a mechanical shaker transducer, etc.) that may be utilized to generate an anti-vibration signal for the active vibration control system. In these example aspects of the present disclosure, a primary source(s) (e.g., vibrations originating from different sources such as, for example, speakers on smart glasses, head motion, self-speech/self-voice, body noise, etc.) may introduce unwanted mechanical vibrations and/or acoustic noise into the smart glasses. The secondary source(s) may be a transducer(s) (e.g., audio-band shaker or transducer such as e.g., a wide-bandwidth piezoelectric transducer, a mechanical shaker transducer, a bone conduction shaker, etc.) that may be used to generate an anti-vibration signal(s). The anti-vibration signal(s) may counter (e.g., cancel or remove) the unwanted vibrations originating from the primary source(s). It should be noted that different placements of smart glasses on users heads may lead to different frequency responses from a driver (e.g., speakers) to the microphones or IMUs (e.g., accelerometers).

In one example aspect of the present disclosure, a method is provided. The method may include detecting, by at least one microphone of an apparatus, at least one audio signal including audio content output from at least one speaker and other audio data from one or more other sources, or caused by the one or more other sources. The other audio data may include determined undesirable vibration noise causing distortion of the at least one audio signal. The method may include determining, by at least one sensor device of the apparatus, at least a subset of the other audio data based in part on determining at least one motion of a user of the apparatus, or motion of one or more other users. The method may include removing or reducing, based on the determined at least one subset of the other audio data, the determined undesirable vibration noise from the at least one audio signal to enable output of sound associated with a modification of the at least one audio signal.

In another example aspect of the present disclosure, an apparatus is provided. The apparatus may include one or more processors and a memory including computer program code instructions. The memory and computer program code instructions are configured to, with at least one of the processors, cause the apparatus to at least perform operations including detecting, by at least one microphone of the apparatus, at least one audio signal including audio content output from at least one speaker and other audio data from one or more other sources, or caused by the one or more other sources. The other audio data may include determined undesirable vibration noise causing distortion of the at least one audio signal. The memory and computer program code are also configured to, with the processor(s), cause the apparatus to determine, by at least one sensor device of the apparatus, at least a subset of the other audio data based in part on determining at least one motion of a user of the apparatus, or motion of one or more other users. The memory and computer program code are also configured to, with the processor(s), cause the apparatus to remove or reduce, based on the determined at least one subset of the other audio data, the determined undesirable vibration noise from the at least one audio signal to enable output of sound associated with a modification of the at least one audio signal.

In yet another example aspect of the present disclosure, a method is provided. The method may include detecting, by at least one microphone of an apparatus, at least one audio signal including audio content output from at least one speaker and other audio data from one or more other sources, or caused by the one or more other sources. The other audio data may include determined undesirable vibration noise causing distortion of the at least one audio signal. The method may include determining, by at least one sensor device of the apparatus, at least one anti-vibration signal. The method may include applying the at least one anti-vibration signal to the determined undesirable vibration noise to remove, or reduce, the determined undesirable vibration noise from the at least one audio signal to enable output of sound associated with a modification of the at least one audio signal.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 illustrates example smart glasses in accordance with an exemplary aspect of the present disclosure.

FIG. 4 illustrates other example smart glasses in accordance with an exemplary aspect of the present disclosure.

FIG. 5 illustrates an example of an artificial reality system comprising a headset, in accordance with an example of the present disclosure.

FIG. 6 illustrates an example acoustic pipeline associated with removal of unwanted vibration noise associated with a device or system in accordance with an example of the present disclosure.

FIG. 7 illustrates a diagram of an example active vibration control system in accordance with an example of the present disclosure.

FIG. 8 illustrates an example flowchart illustrating operations for removal of unwanted vibration noise associated with a device or system in accordance with an example of the present disclosure.

FIG. 9 illustrates another example flowchart illustrating operations for removal of unwanted vibration noise associated with a device or system in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, unwanted vibration(s), undesirable vibration(s) and/or unwanted noise may refer to dynamic vibrational energy in the form of sound or vibration that may be sensed by sensors in a device (e.g., smart glasses).

As referred to herein, self-voice (also referred to herein as own voice) may refer to the voice of a user/person wearing a device (e.g., smart glasses).

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

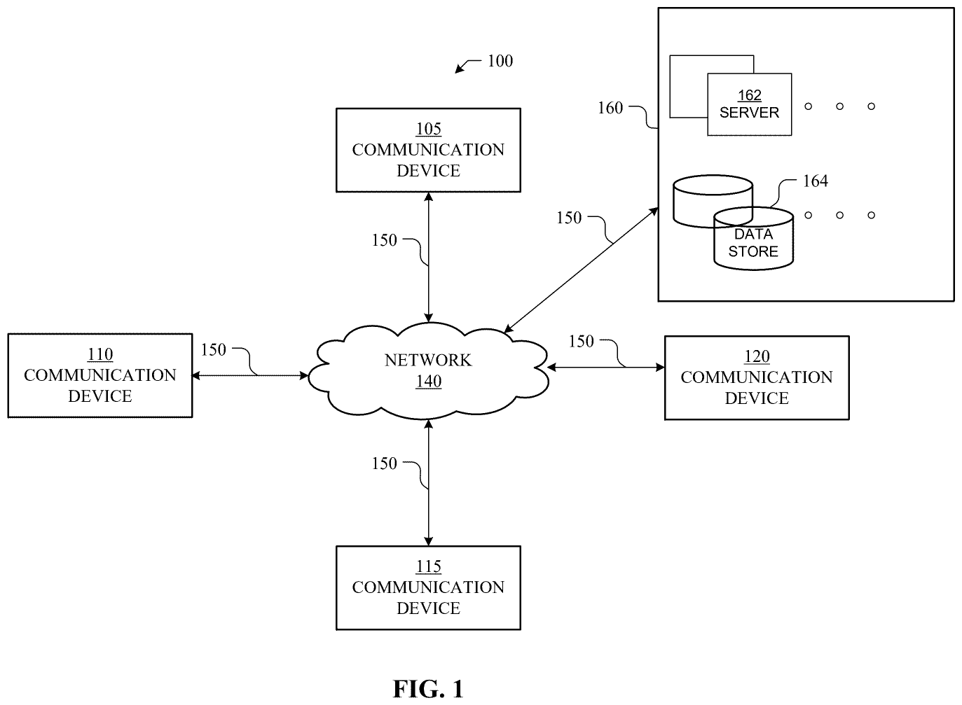

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

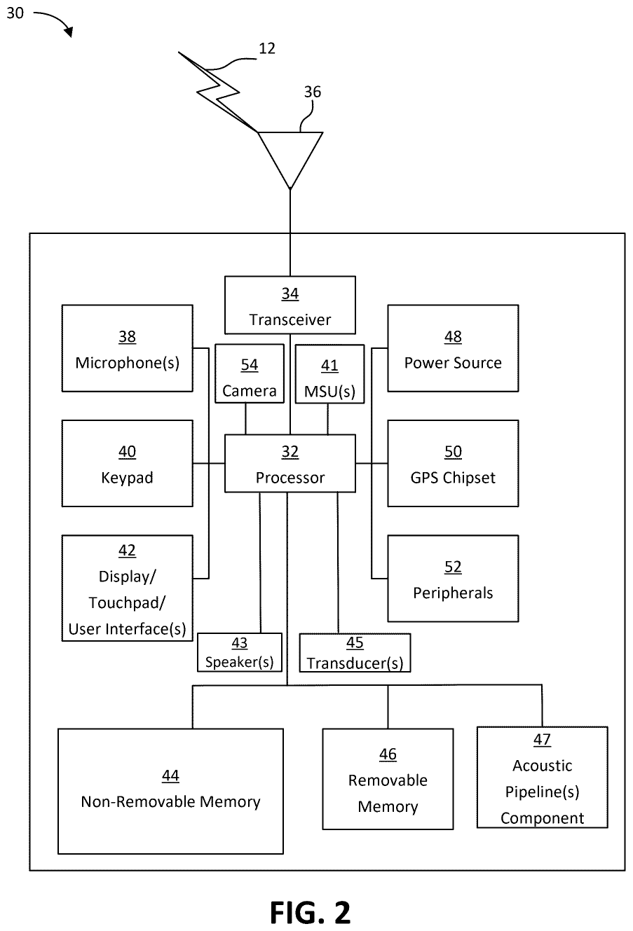

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker(s) 43, microphone(s) 38, a keypad 40, one or more motion sensor units (MSUs) 41, a transducer(s) 45, an acoustic pipeline(s) component 47, a display, touchpad, and/or a display, touchpad, and/or a display, touchpad, and/or user interface(s) 42, a power source 48, a global positioning system (GPS) chipset 50, and other peripherals 52. In some examples, the MSU(s) 41 may be one or more inertial measurement units (IMUs), or one or more accelerometers.

In an example in which the MSU(s) 41 may be an IMU(s), the IMU(s) may include an accelerometer and/or a gyroscope. In some examples, the MSU(s) 41 may be an accelerometer. In some other examples, the MSU(s) 41 may be a contact microphone. The accelerometer of the IMU(s) may measure/determine motion, acceleration, linear velocity and/or position associated with multiple axes (e.g., x-axis, y-axis, z-axis, etc.) relative to a reference frame. The gyroscope of the IMU(s) may measure/determine attitude, orientation and/or angular velocity associated with the multiple axes. The MSU(s) 41 may detect one or more vibrations (e.g., acoustic and/or mechanical vibrations) associated with the speaker(s) 43, microphone(s) 38 and from one or more other sources (e.g., self-voice, body noises, etc.). Additionally, in some example aspects, the transducer 45 (e.g., a mechanical shaker transducer) may detect one or more vibrations (e.g., audio/mechanical vibrations) associated with the speaker(s) 43 and/or microphone(s) 38.

In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

In some examples, the acoustic pipeline(s) component 47 may facilitate acoustic feedback cancellation and/or may facilitate removal of unwanted/undesirable vibration (e.g., acoustic and/or mechanical vibration) associated with a device (e.g., UE 30). In some example aspects, the acoustic pipeline(s) component 47 may be referred to herein as a digital signal processor(s) (DSP(s)) 47. In some example aspects, the acoustic pipeline(s) component 47 may be embodied on a chip(s) or processor(s) designed to support audio pathways in a device such that audio signals may be decoded, amplified, and/or the like. The acoustic pipeline(s) component 47 may include one or more microphones, one or more acoustic feedback cancellers (AFCs) associated with each of the microphones, one or more feedforward processors, and/or one or more other components.

### Exemplary Smart Glasses

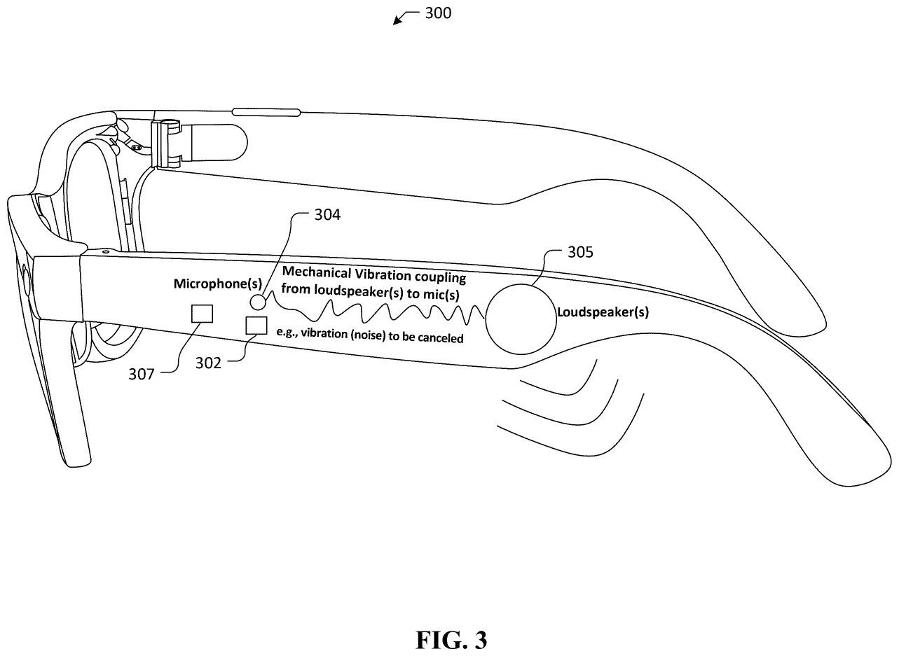

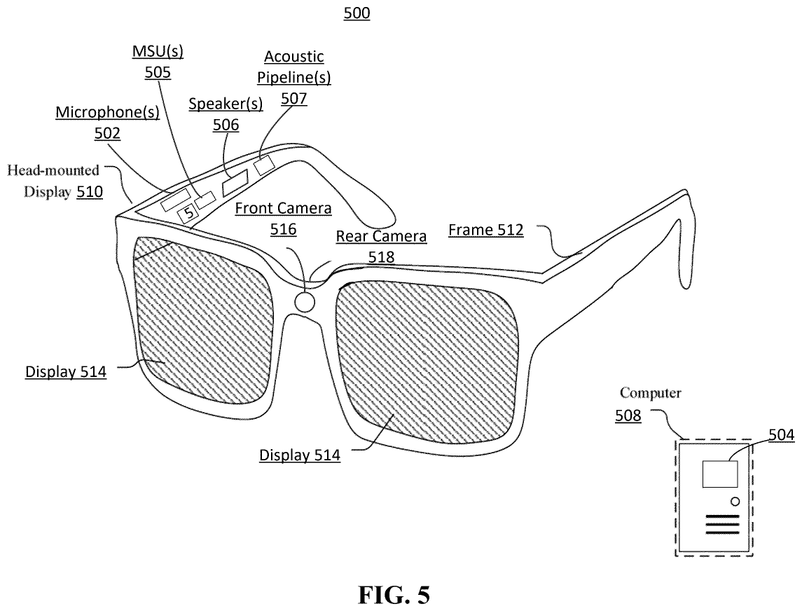

FIG. 3 illustrates example smart glasses 300 in accordance with an exemplary aspect of the present disclosure. In some examples, the smart glasses 300 may be an example of the artificial reality system 500 of FIG. 5. In the example of FIG. 3, the smart glasses 300 may include one or more vibration sensors 302 (e.g., MSU(s) 41). The one or more vibration sensors 302 may be placed/located at proximities (e.g., distances (e.g., predetermined distances)) to locations of one or more microphones 304 (e.g., microphone(s) 38). The one or more vibration sensors 302 may detect one or more vibrations (e.g., noise) from one or more microphones 304 to be canceled (e.g., removed). In some instances, the air-borne microphones may not accurately capture the vibrations accurately. In this regard, the one or more vibration sensors 302 may serve as a reference source for an amount of unwanted vibrations being captured by the one or more microphones 304. The unwanted vibrations which may be detected by the one or more vibration sensors 302 may be caused by mechanical and/or acoustic coupling from a loudspeaker(s) 305 (e.g., speaker(s) 43) to a corresponding microphone of the one or more microphones 304.

In addition to the vibrations induced by a driver such as, for example, a loudspeaker(s) 305, there may also be other vibrations arising from a self-voice (e.g., a self-voice of a user of the smart glasses 300), body noise such as footsteps, body motions, movements of glasses, and environmental noise, etc. In some example aspects, an acoustic pipeline 307 (e.g., acoustic pipeline(s) component 47) may be utilized/implemented by the smart glasses 300 to remove one or more items of unwanted vibrations determined/detected by the one or more vibration sensors 302, as described more fully below.

### Other Exemplary Smart Glasses

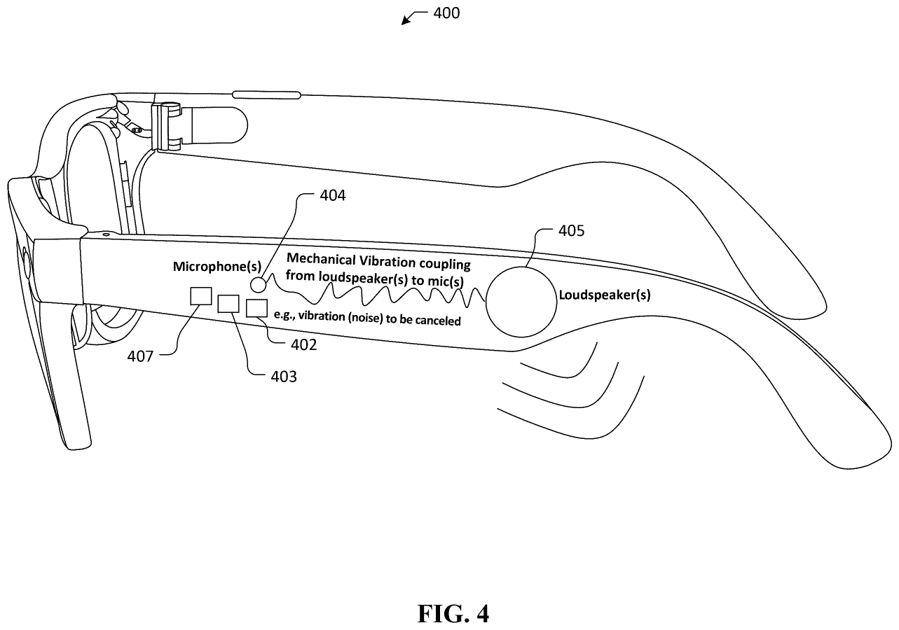

FIG. 4 illustrates example smart glasses 400 in accordance with an exemplary aspect of the present disclosure. In some examples, the smart glasses 400 may be an example of the artificial reality system 500 of FIG. 5. In the example of FIG. 4, the smart glasses 400 may include one or more mechanical transducers 402 (e.g., a mechanical shaker transducer(s), a bone-conduction transducer(s), a piezoelectric sensor(s), a voice coil(s), etc.). The one or more mechanical transducers 402 may detect/determine one or more vibrations (e.g., noise) at a microphone of one or more microphones 404 in which the microphone may detect and amplify the vibration coupling from one or more loudspeakers 405.

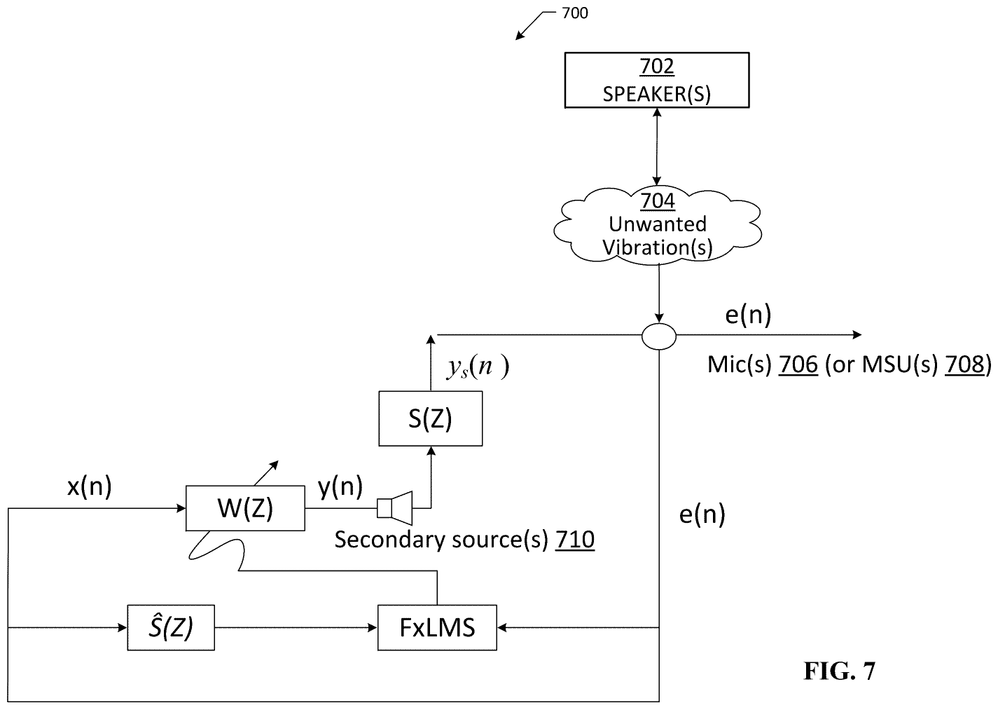

In some examples, the one or more mechanical transducers 402 may be placed at proximities (e.g., predetermined distances) to the one or more microphones 404 and/or locations of one or more vibration sensors 403 (e.g., MSU(s) 41 (e.g., accelerometers)). The one or more mechanical transducers 402 may serve as a secondary source(s) to minimize or reduce unwanted mechanical and/or acoustic coupling vibrations sensed/determined by the one or more vibration sensors 403 (e.g., similar to a feedback active noise control (FBANC). In an example of a FBANC, the sensing element (e.g., an air-borne acoustic microphone for the acoustic energy and a vibration sensor for the case of mechanical vibrations) may sense the residual energy, and based on the residual signal (also known as an error signal), coefficients of a digital filter may be adaptively updated in an adaptive filter architecture to create an anti-noise filter which may be fed back to a secondary source to adaptively minimize the mechanical and acoustic signals. In some example aspects, an acoustic pipeline 407 (e.g., acoustic pipeline(s) component 47, system 700 of FIG. 7) may be utilized/implemented by the smart glasses 400 to remove one or more items of unwanted vibrations determined/detected by the one or more vibration sensor(s) 403, as described more fully below.

### Exemplary Artificial Reality System

FIG. 5 illustrates an example artificial reality system 500. The artificial reality system 500 may include a head-mounted display (HMD) 510 (e.g., smart glasses and/or augmented/virtual reality device) comprising a frame 512, one or more displays 514, a computing device 508 (also referred to herein as computer 508) and a controller 504. In some examples, the HMD 510 may capture one or more items of text from one or more images/videos associated with a real world environment in the field of view of one or more cameras (e.g., cameras 516, 518) of the artificial reality system 500. The HMD 510 may utilize the captured text from the one or more images/videos to trigger one or more actions/functions by the artificial reality system 500. The displays 514 may be transparent or translucent allowing a user wearing the HMD 510 to look through the displays 514 to see the real world (e.g., real world environment) and displaying visual artificial reality content to the user at the same time. The HMD 510 may include one or more speakers 506 and one or more microphones 502 that may provide audio content to users. In some examples, the audio content may be audio artificial reality content. The HMD 500 may also include one or more motion sensor units (MSU(s)) 505 (e.g., MSU(s) 41), one or more transducers 5 (e.g., mechanical transducer(s) 402) and one or more acoustic pipelines 507. The one or more acoustic pipelines 507 (e.g., acoustic pipeline component(s) 47, acoustic pipeline 307, acoustic pipeline 407) may be implemented by the HMD 510 to facilitate removal of one or more vibrations (e.g., noise) from the artificial reality system 500. The HMD 510 may include one or more cameras 516, 518 which may capture images and/or videos of environments. In one exemplary embodiment, the HMD 510 may include a camera(s) 518 which may be a rear-facing camera tracking movement and/or gaze of a user's eyes.

One of the cameras 516 may be a forward-facing camera capturing images and/or videos of the environment that a user wearing the HMD 510 may view. The camera(s) 516 may also be referred to herein as a front camera(s) 516. The HMD 510 may include an eye tracking system to track the vergence movement of the user wearing the HMD 510. In one exemplary embodiment, the camera(s) 518 may be the eye tracking system. In some exemplary embodiments, the camera(s) 518 may be one camera configured to view at least one eye of a user to capture a glint image(s) (e.g., and/or glint signals). The camera(s) 518 may also be referred to herein as a rear camera(s) 518. The HMD 510 may include a microphone of the audio device 506 to capture voice input from the user. The artificial reality system 500 may further include a controller 504 comprising a trackpad and one or more buttons. The controller 504 may receive inputs from users and relay the inputs to the computing device 508. The controller 504 may also provide haptic feedback to one or more users. The computing device 508 may be connected to the HMD 510 and the controller 504 through cables or wireless connections. The computing device 508 may control the HMD 510 and the controller 504 to provide the augmented reality content to and receive inputs from one or more users. In some example embodiments, the controller 504 may be a standalone controller or integrated within the HMD 510. The computing device 508 may be a standalone host computer device, an on-board computer device integrated with the HMD 510, a mobile device, or any other hardware platform capable of providing artificial reality content to and receiving inputs from users. In some exemplary embodiments, the HMD 510 may include an artificial reality system/virtual reality system.

### Exemplary System Operation

In some devices such as, for example, cellular phones, tablets, smart glasses, and/or the like may have speakers and microphones within the devices. For instance, in some examples these devices may be used as a hearing amplification or hearing correction type of device. As such, these devices may utilize a microphone signal for sound that may need to be heard by a user and may boost the sound via the speakers or may amplify the sound via the speakers.

A problem may arise when the speakers move and they generate sound associated with generated vibrations (e.g., acoustic and/or mechanical vibration(s)), and these vibrations may get captured/sensed by the microphones that detect sound and may add noise to the sound based on the vibrations which may reduce the overall quality of the microphone signal that is being amplified. This noise (e.g., vibrations) included in the sound may create instability and feedback as well as distortion which may prevent applying additional amplification to the speakers. In some examples, the feedback may cause a buzz sound output by the speakers which may make it more challenging for a user to intelligibly hear the intended audio.

To eliminate (or minimize) unwanted acoustic or mechanical vibration coupling, some existing systems may do so passively to improve the overall acoustic-mechanical designs (e.g., dipole transducer designs, arrange microphones in locations of a device in which mechanical or acoustical energy from a loudspeaker(s) has a null (e.g., regions with minimal energy content), isolating mics by dampening materials, etc.).

However, some example aspects of the present disclosure may provide approaches and techniques to utilize active vibration control approaches to reduce the unwanted acoustic and/or mechanical vibrations coupling to one or more microphones (e.g., associated with a microphone array) of a device.

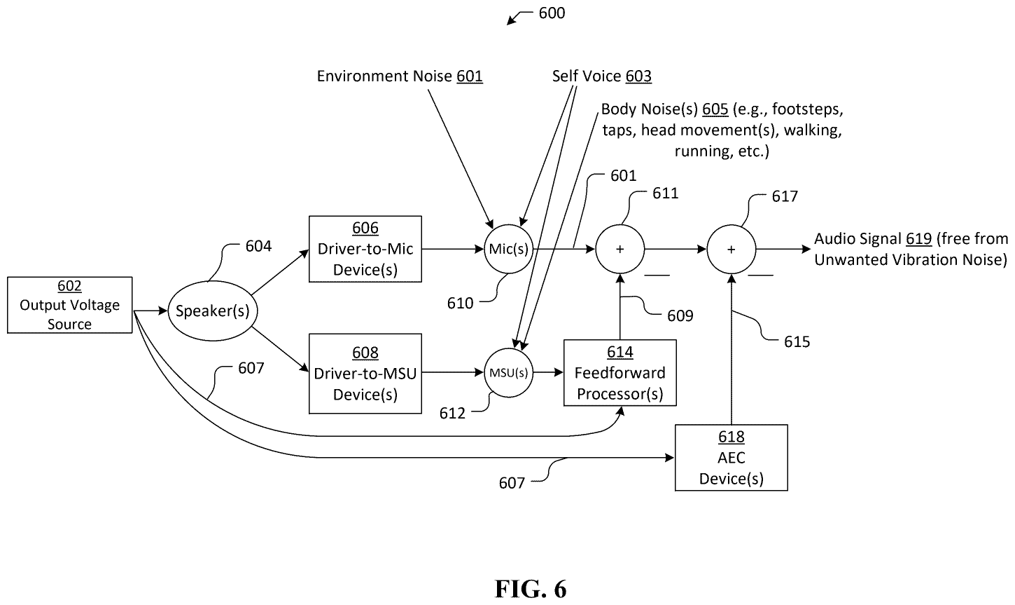

Referring now to FIG. 6, a diagram illustrating an example acoustic pipeline in accordance with an exemplary aspect of the present disclosure is provided. The acoustic pipeline 600 (e.g., acoustic pipeline(s) component 47) may facilitate removal and/or minimizing of unwanted vibrations (e.g., acoustic/mechanical vibrations, noise, etc.) associated with a device (e.g., smart glasses 300, artificial reality system 500). It is contemplated that the process of acoustic pipeline 600 may occur on a chip(s) or a processor(s) generated to support audio pathways in a device, such that audio signals may be decoded, amplified and/or the like. In some example aspects, the acoustic pipeline 600 may be embodied within the device (e.g., smart glasses 300, artificial reality system 500).

The acoustic pipeline 600 may include at least one output voltage source 602, one or more speakers (e.g., speaker(s) 604), one or more microphones (e.g., mic(s) 610), at least one device-to-mic device 606, at least one driver-to-MSU(s) device 608, at least one MSU(s) 612 (e.g., an accelerometer(s)), at least one feedforward processor(s) 614, and at least one acoustic echo cancellation (AEC) device 618.

In the example of FIG. 6, the device may capture sound/audio by the mic(s) 610 and the sound/audio may also be detected by one or more of the components of the acoustic pipeline 600, and may be rendered/output by the speaker(s) 604. In the example of FIG. 6, some of the sound/audio (e.g., a conversation of a user of the device with one or more other users) output by the speaker(s) 602 may be captured/heard by an ear of a user associated with the device (e.g., a user wearing the artificial reality system 500, or wearing the smart glasses 300). Additionally, some of the sound/audio may couple back to the mic(s) 610, which may cause feedback (e.g., a buzzing like noise) associated with the device. Further, other items of audio of the sound such as noise from a user's voice (e.g., self-voice 603) of the device, as well as body noise (body noise(s) 605) (e.g., footsteps, taps, quick movements/motion of a user(s), etc.) and environment noise (e.g., environment noise 601) (e.g., background noise (e.g., other people talking in the background, birds chirping, music playing, etc.)) may be coupled back to the mic(s) 610. These other items of the sound/audio such as noise may be unwanted/undesired audio that the acoustic pipeline 600 may minimize to reduce or remove acoustic feedback at the mic(s) 610. This audio noise may be associated with detected vibrations (e.g., motions, movements causing audio, sound of a user's own voice (e.g., self-voice) being detected by an accelerometer (e.g., MSU(s) 612)). In some examples, the taps may include, but are not limited to, tapping of/on a device (e.g., smart glasses 300, artificial reality system 500) such as voluntarily or involuntarily taps/touches to the device that may be sensed by one or more microphones (e.g., mic(s) 610).

For instance, the MSU(s) 612 may detect unwanted noise (e.g., vibrations) such as one or more items of body noise (e.g., body noise 605) associated with a user such as, for example, footsteps, walking, running, taps, movements of the user, the self-voice (e.g., self-voice 603) of the user and other noises associated with a user and/or other users. In some examples, an accelerometer of the MSU(s) 612 may determine body noise associated with a body, or body parts, of the user of the device (e.g., artificial reality system 600) and/or bodies of other users based on the user and the other users detected motion/movements. For example, when a user speaks, their vocal tract may produce speech through mechanical vibrations that may be detected by sensitive accelerometers, such as contact microphones. These vibrations may propagate through the body and may be sensed by these MSUs (such as sensitive accelerometers and/or contact microphones). This unwanted noise (e.g., vibrations) may detract from the actual audio/sound that the user of the device (e.g., artificial reality system 600, smart glasses 300) desires to hear (e.g., user conversation(s), amplification/enhancement of other audio content (e.g., desired music) in an environment (e.g., an office, a restaurant, etc.).

Additionally, in some examples, this unwanted noise (e.g., vibrations) may undesirably impact other sensors of the device. For example, in an instance in which the unwanted vibration may exceed a predetermined threshold, such excessive unwanted vibration may impact other sensors of the device such as for example a camera(s) (e.g., camera 516, camera 518, camera 54) capturing images/video(s) and/or associated audio, which may cause a jitter effect on the captured image(s)/video(s) and associated audio captured by the camera. In some examples, the jitter effect may cause a distortion in the accuracy and/or resolution of the image(s)/video(s) and/or associated audio and may cause a delay in output of the image(s)/video(s) and audio by the device. As such, the device may implement the acoustic pipeline 600 to remove or minimize the unwanted detected vibration (e.g., noise) such that the unwanted vibration (e.g., noise) may not undesirably bias the information (e.g., audio, videos, images, etc.) captured by sensors (e.g., mic(s) 610, cameras 516, 518, 54, MSU(s) 41, MSU(s) 612, etc.) of the device.

In the example of FIG. 6, the output voltage supply 602 may drive, or provide, power to the acoustic pipeline 600. For example, the output voltage supply 602 may provide power to the speaker(s) 602, the mic(s) 610, feedforward processor(s) 614 and the AEC device(s) 618 and other components.

The driver-to-mic(s) device 606 may capture (or may be a path(s) for) the sound/audio from the speaker(s) 604 to the mic(s) 610, for example through the air and through a structure such as the device. The driver-to-MSU(s) device 608 may capture (or may be a path(s) for) the sound/audio from the speaker(s) 604 to the MSU(s) 612 (e.g., an accelerometer) for example through the air and the structure (e.g., the device). As described above, in addition to the sound/audio from the speaker(s) 604 captured by the mic(s) 610 (e.g., via driver-to-mic(s) device 606), audio/sound from other sources in an environment (e.g., a real-world environment (e.g., a scene of a user conversation, etc.)) may be captured by the mic(s) 610. In some instances, this sound/audio from other sources may distort the sound/audio (e.g., a conversation, etc.) from the speaker(s) 604 that the user of the device may desire to hear with an ear(s) of the user. The sound/audio may be from other sources such as, for example, environment noise 601 (e.g., one or more background noises, etc.) detected/captured by the mic(s) 610 and/or a self-voice 603 of the user captured/detected by the mic(s) 610. In some examples, some, or all of, the environment noise 605 may be output from the mic(s) 610, for example, to output 611.

Additionally, the MSU(s) 612 may detect the self-voice 603 and one or more body noises 605 associated with the user of the device. In some examples, the MSU(s) 612 may detect the self-voice of the user of the device based on detecting/determining the user is speaking based on determined rhythmic movements of the user's mouth moving. As described above, in some examples the self-voice may be captured by an accelerometer (e.g., propagation of mechanical vibrations from a vocal tract of a user to other parts of the body such as for example a face. The MSU(s) 612 may also determine one or more body noises 605. The MSU(s) 612 may determine the one or more body noises 605 based on determining one or more movements/motion (e.g., acceleration in one or more determined directions (e.g., x, y, z axes)) of body parts of the user. In some other example aspects, the MSU(s) 612 may determine the one or more body noises 605 based on determining one or more movements/motion of body parts of other users in a vicinity of the environment of the user of the device.

The MSU(s) 612 may provide both the detected self-voice 603 and the one or more body noises 605 to the feedforward processor(s) 614. The feedforward processor(s) 614 may subtract the self-voice 603 and the one or more body noises 605 (e.g., of unwanted vibration(s) noise) from the audio/sound signal 607 received by the speaker(s) 604. The feedforward processor(s) 614 may be a pathway device to provide an audio signal 609 with the self-voice 603 and the one or more body noises 605 subtracted out from the audio/sound signal 607 to be provided to an output 611. In an example of speech enhancement, conversation focus, and hearing amplification, the feedforward processor(s) 614 may also add digital gain to further amplify the output before rendering the signal 619 to the user(s). In some examples, the feedforward processor(s) 614 may implement one or more DSP applications and/or DSP algorithms to add the digital gain to further amplify the output before rendering the signal 619 to the user(s).

The AEC device(s) 618 may detect one or more echo signals from the audio/sound signal 607 and may remove the echo signals from the audio/sound signal 607 to provide an echo free, or reduced echo, audio signal 615 to an output 617. In this manner, some, or all, of the echo signals associated with the audio/sound signal 607 may not be heard by a user of the device.

The output 617 may receive some or all of the environment noise 601 and the audio signal 609 from the output 611 and may receive the audio signal 615 from the AEC device(s) 618 to generate an output audio signal 619 that may be free from (e.g., lacks) unwanted vibration noise such as self-voice 603 and one or more body noises 605. In some examples, the aim of the system 600 may be to provide an enhanced version of the acoustic scene (e.g., using acoustic beamforming techniques and free of noise for a user). As described above, in such examples of speech enhancement, conversation focus, and hearing amplification, feedforward processor(s) 614 (e.g., by implementing DSP applications/algorithms) may also add digital gain to further amplify the output before rendering the signal 619 to a user(s).

Referring now to FIG. 7, a diagram illustrating an example active vibration control system in accordance with the present disclosure is provided. The system 700 may include a speaker(s) 702 (e.g., a loudspeaker) that may generate audio/sound for a user associated with a device (e.g., smart glasses 400, artificial reality system 500). In some examples, the system 700 may be an example of acoustic pipeline 407 of FIG. 4. The speaker(s) 702 may be a source(s) of the unwanted vibration(s) 704. Additionally, other sources (e.g., self-voice, one or more items of body noise) may be sources of the unwanted vibration(s) 704. A microphone(s) mic(s) 706 may sense/detect the unwanted vibration(s) 704. A secondary source(s) 710 may generate an anti-noise signal(s) y(n) (e.g., an anti-vibration signal(s)) that may be utilized by the system 700 to cancel out, remove or minimize, the unwanted vibration(s) 704. In some examples, the secondary source(s) 710 may be an audio-band shaker(s), or a transducer(s) (e.g., a wide-bandwidth piezoelectric transducer(s), a miniaturized bone conduction shaker(s), a mechanical shaker transducer(s), or other transducers). In some examples, the secondary source(s) 710 may be an example of vibration sensor(s) 403 of FIG. 4.

The anti-noise signal(s) y(n) may be determined/computed by filtering an estimate of the reference signal x(n) in the digital vibration control filter W(Z), which may be continuously adapted, by utilizing a Filtered-X Least Mean Square (LMS) approach/technique, to the given signals x(n) and e(n). The e(n) signal may be an error signal. In adaptive noise control (ANC), an aim is to minimize the error signal e(n) using an adaptive approach. The properties and coefficients of the digital vibration control filter W(Z) may be adaptively updated by utilizing the FxLMS filter. To provide a destructive superposition, the determined anti-noise signal(s) y(n), determined by the digital vibration control filter W(Z), may be inverted by the secondary source(s) 710 before being emitted by the secondary source(s) 710. The inverse anti-noise signal(s) yₛ(n) may be output by the secondary source(s) 710 along the path S(Z) to cancel out the unwanted vibration(s) 704 at the mic(s) 706. For instance, the anti-noise signal may be an inverse of a detected initial noise signal and when the anti-noise signal is added to the initial noise signal the result may be 0 (e.g., a cancellation of the unwanted initial noise signal). In this regard, the mic(s) 706 may capture audio (e.g., an audio signal(s)) that is free from having, or lacks (e.g., removed), unwanted vibration(s) 704 noise. This audio that is clear of the unwanted vibration 704 may result in crisper (e.g., less distorted) audio heard by a user of a device (e.g., smart glasses 400, artificial reality system 500).

The FxLMS filter may be utilized in the system 700 since an error signal may not be correctly aligned in time with the estimate/determination of the reference signal x(n), due to the presence of the secondary path S(Z). To account for the error signal not being correctly aligned in time with the determination of the reference signal x(n), an estimated secondary path filter Ŝ(Z) may be placed in the reference signal x(n) path, which may be realized/determined by filtered-X LMS. The filtered-X LMS determined by the FxLMS filter may adaptively update weights of the control filter W(Z).

In another example aspect of the present disclosure, a motion sensor unit(s) (MSU(s)) 708 (e.g., MSU(s) 41, vibration sensor(s) 302) e.g., an accelerometer such as for example an audio-band accelerometer(s))) may be used to actively sense the vibrations associated with a device (e.g., smart glasses 400, artificial reality system 500). The MSU(s) 708 may be placed/located at an area(s) close to the mic(s) 706 to precisely capture the unwanted vibrations 704 at areas (e.g., important areas). In some examples, the important areas may be areas within smart glasses where sensors (e.g., microphones, cameras, IMUs, eye-tracking sensors, etc.) are placed/located. The motion sensor unit(s) 708 and/or the mic(s) 706 may sense the unwanted vibration(s) 704 (e.g., signal(s) e(n)) and may determine estimates of the secondary path (e.g., S(Z)).

Based on a determined estimate(s) of the secondary path (e.g., S(Z)), an FxLMS application (e.g., the FxLMS filter) may be utilized to adaptively estimate and minimize, remove or cancel, the sensed unwanted vibration(s) 704 (e.g., signal(s) e(n)) at the areas/locations close to the mic(s) 706.

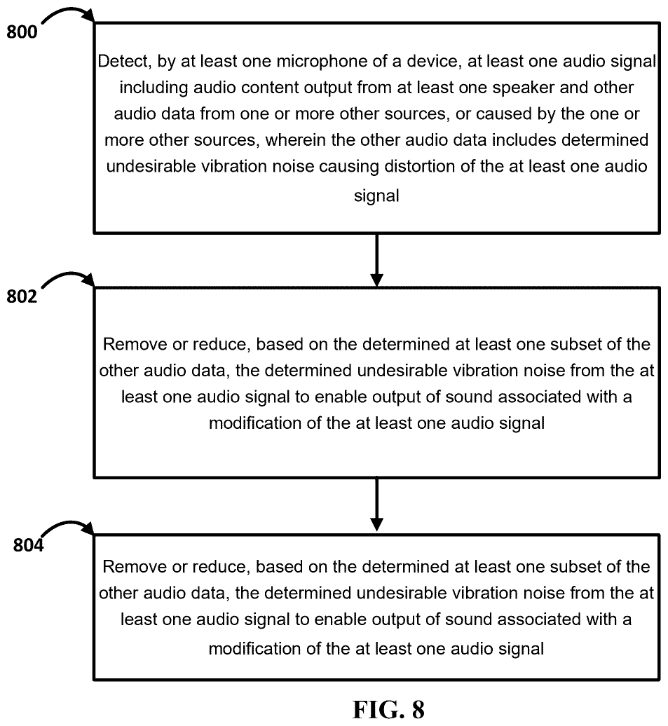

FIG. 8 illustrates an example flowchart illustrating operations for removal of, or reducing, unwanted vibration noise according to an example of the present disclosure. At operation 800, a device (e.g., smart glasses 300, artificial reality system 500) may detect, by at least one microphone (e.g., microphone(s) 304, microphone(s) 502, mic(s) 610) of the device, at least one audio signal including audio content output from at least one speaker (e.g., loudspeaker(s) 305, speaker(s) 506, speaker(s) 604) and other audio data from one or more other sources, or caused by the one or more other sources. The other audio data may include determined undesirable vibration noise causing distortion of the at least one audio signal.

At operation 802, a device (e.g., smart glasses 300, artificial reality system 500) may determine, by at least one sensor device (e.g., vibration sensor(s) 302, MSU(s) 505, MSU(s) 612) of the device, at least a subset of the other audio data based in part on determining at least one motion of a user of the device, or motion of one or more other users.

At operation 804, a device (e.g., smart glasses 300, artificial reality system 500) may remove or reduce, based on the determined at least one subset of the other audio data, the determined undesirable vibration noise from the at least one audio signal to enable output of sound associated with a modification of the at least one audio signal.

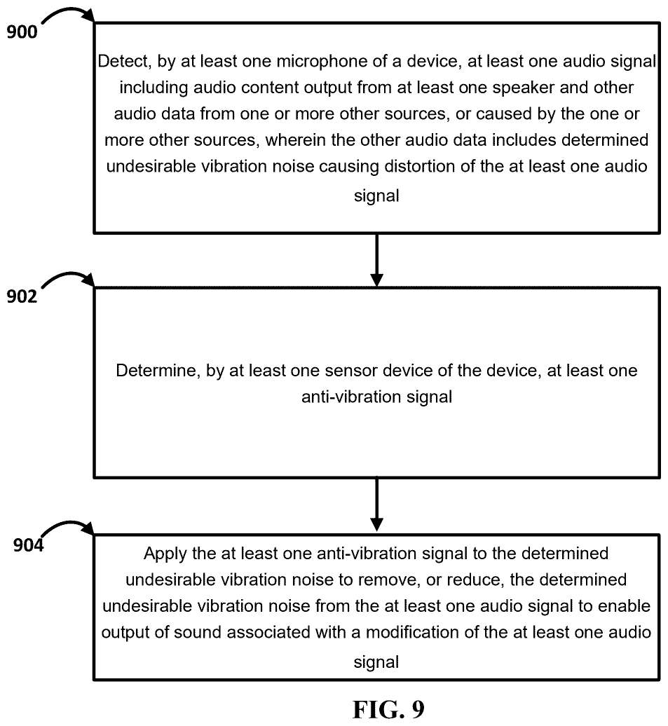

FIG. 9 illustrates another example flowchart illustrating operations for removal of, or reducing, unwanted vibration noise according to an example of the present disclosure. At operation 900, a device (e.g., smart glasses 400, artificial reality system 500) may detect, by at least one microphone (e.g., microphone(s) 404, microphone(s) 502, mic(s) 706) of the device, at least one audio signal including audio content output from at least one speaker (e.g., loudspeaker(s) 405, speaker(s) 506, speaker(s) 702) and other audio data from one or more other sources, or caused by the one or more other sources. The other audio data may include determined undesirable vibration noise (e.g., unwanted vibration(s) 704) causing distortion of the at least one audio signal.

At operation 902, a device (e.g., smart glasses 400, artificial reality system 500) may determine, by at least one sensor device (e.g., one or more mechanical transducers 402, transducer(s) 5, secondary source(s) 710) of the device, at least one anti-vibration signal (e.g., anti-noise signal y(n)). At operation 904, a device (e.g., smart glasses 400, artificial reality system 500) may apply the at least one anti-vibration signal to the determined undesirable vibration noise to remove, or reduce, the determined undesirable vibration noise from the at least one audio signal to enable output of sound associated with a modification of the at least one audio signal.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
detecting, by at least one microphone of an apparatus, at least one audio signal comprising audio content output from at least one speaker and other audio data from one or more other sources, or caused by the one or more other sources, wherein the other audio data comprises determined undesirable vibration noise causing distortion of the at least one audio signal;
determining, by at least one sensor device of the apparatus, at least a subset of the other audio data based in part on determining at least one motion of a user of the apparatus, or motion of one or more other users; and
removing or reducing, based on the determined at least one subset of the other audio data, the determined undesirable vibration noise from the at least one audio signal to enable output of sound associated with a modification of the at least one audio signal.

2. The method of claim 1, further comprising:
causing output, by the at least one speaker or a second speaker, of the modification of the at least one audio signal being free from comprising the determined undesirable vibration noise, or comprises a reduction in noise of the determined undesirable vibration noise.

3. The method of claim 1, further comprising:
determining that the subset of the other data comprises at least one of a self-voice of a voice of the user or the one or more other users, or one or more items of body noise associated with one or more detected movements of one or more body parts of the user or the one or more other users.

4. The method of claim 1, further comprising:
determining that the subset of the other data comprises one or more items of environment noise associated with a background of a real world environment that the user is located within.

5. The method of claim 1, further comprising:
determining that the at least one sensor device is located within a predetermined distance to a location of the at least one microphone.

6. The method of claim 1, wherein the apparatus comprises at least one of an artificial reality device, a head-mounted display, or smart glasses.

7. The method of claim 1, wherein:
the removing, or the reducing, of the determined undesirable vibration noise comprises minimizing distortion, interference, or jitter associated with one or more other sensors of the apparatus.

8. The method of claim 1, wherein the distortion comprises audio feedback.

9. The method of claim 1, wherein the at least one sensor comprises at least one of an inertial measurement unit or an accelerometer.

10. The method of claim 1, wherein the at least one audio signal is associated with a conversation of the user with the one or more other users.

11. An apparatus comprising:
one or more processors; and
at least one memory storing instructions, that when executed by the one or more processors, cause the apparatus to:
detect, by at least one microphone of the apparatus, at least one audio signal comprising audio content output from at least one speaker and other audio data from one or more other sources, or caused by the one or more other sources, wherein the other audio data comprises determined undesirable vibration noise causing distortion of the at least one audio signal;
determine, by at least one sensor device of the apparatus, at least a subset of the other audio data based in part on determining at least one motion of a user of the apparatus, or motion of one or more other users; and
remove or reduce, based on the determined at least one subset of the other audio data, the determined undesirable vibration noise from the at least one audio signal to enable output of sound associated with a modification of the at least one audio signal.

12. The apparatus of claim 11, wherein when the one or more processors execute the instructions, the apparatus is configured to:
cause output, by the at least one speaker or a second speaker, of the modification of the at least one audio signal being free from comprising the determined undesirable vibration noise, or comprises a reduction in noise of the determined undesirable vibration noise.

13. The apparatus of claim 11, wherein when the one or more processors execute the instructions, the apparatus is configured to:
determine that the subset of the other data comprises at least one of a self-voice of a voice of the user or the one or more other users, or one or more items of body noise associated with one or more detected movements of one or more body parts of the user or the one or more other users.

14. The apparatus of claim 11, wherein when the one or more processors execute the instructions, the apparatus is configured to:
determine that the subset of the other data comprises one or more items of environment noise associated with a background of a real world environment that the user is located within.

15. The apparatus of claim 11, wherein when the one or more processors execute the instructions, the apparatus is configured to:
determine that the at least one sensor device is located within a predetermined distance to a location of the at least one microphone.

16. The apparatus of claim 11, wherein the apparatus comprises at least one of an artificial reality device, a head-mounted display, or smart glasses.

17. The apparatus of claim 11, wherein when the one or more processors execute the instructions, the apparatus is configured to:
perform the remove, or the reduce, of the determined undesirable vibration noise by minimizing distortion, interference, or jitter associated with one or more other sensors of the apparatus.

18. The apparatus of claim 11, wherein the distortion comprises audio feedback.

19. A method comprising:
detecting, by at least one microphone of an apparatus, at least one audio signal comprising audio content output from at least one speaker and other audio data from one or more other sources, or caused by the one or more other sources, wherein the other audio data comprises determined undesirable vibration noise causing distortion of the at least one audio signal;
determining, by at least one sensor device of the apparatus, at least one anti-vibration signal; and
applying the at least one anti-vibration signal to the determined undesirable vibration noise to remove, or reduce, the determined undesirable vibration noise from the at least one audio signal to enable output of sound associated with a modification of the at least one audio signal.

20. The method of claim 19, wherein, the at least on sensor comprises at least one of an audio band shaker or a transducer.
